(19) United States
(12) Patent Application Publication
(10) Pub. No.: US 2007/0135206 A1
(43) Pub. Date: Jun. 14, 2007

(54) GAMING MACHINE AND GAME SYSTEM

(75) Inventor: Yukinori Inamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/567,393

(22) Filed: Dec. 6, 2006

(30) Foreign Application Priority Data
Dec. 9, 2005 (JP) 2005-356632

(51) Int. Cl. A63F 13/00

(52) U.S. Cl. 463/20

(57) ABSTRACT

A gaming machine has a first determination unit, a selection unit, and a bonus game execution unit. The receiving unit receives a game medium. The first determination unit determines whether or not a payout number based on the result of a lottery is equal to or more than a threshold amount at which tax obligation occurs. The selection unit selects, based on an input made by a player, whether or not to execute a bonus game which gives the player an opportunity for profit, when the first determination unit determines that the payout number is equal to or more than the threshold amount. The bonus game execution unit executes the bonus game when the selection unit selects to execute the bonus game.

### CROSS REFERENCE TO RELATED APPLICATION

This application is based upon and claims the benefit of priority from the prior Japanese Patent Application No. 2005-356632, filed on Dec. 9, 2005, the entire contents of which are incorporated herein by reference.

### BACKGROUND OF THE INVENTION

1. Field of the Invention

The present invention relates to a gaming machine that gives a payout in accordance with a lottery result, and also to a game system that includes the gaming machine and a server.

2. Description of Related Art

There are many gaming machines that pay out game media such as medals and coins, in accordance with a lottery result. For example, there are card-game machines, slot machines, or the like. In a card-game machine, images of playing cards are displayed, and a game such as a poker game and a blackjack game progresses in accordance with operations made by players. In a slot machine, various symbols presented on several reels are variably displayed and, when a predetermined combination of symbols is stopped on a predetermined pay line, a payout corresponding to the combination is given. The reel includes a so-called video reel. In the above-described gaming machines, a player plays a game hoping that a large amount of payout will be given.

In some countries or regions, when a player wins a large amount of payout equal to or larger than a threshold amount, e.g., 1200 dollars, the player is obliged to pay a predetermined percentage, e.g., 30%, of the payout as a tax. In this case, the player has to take a tax payment procedure. While undergoing the tax payment procedure, the player may lose excitement of winning the large amount of payout, which spoils fun of a game.

A known gaming machine allows a tax payment procedure to be taken swiftly in order to retain fun of a game (see Japanese Unexamined Patent Publication Nos. 2005-168755 and 2005-192991). In the gaming machine disclosed in the above-mentioned documents, when a player wins a large amount of payout which involves tax payment, a tax payment procedure is taken place on the gaming machine. Consequently, the player can swiftly take the tax payment procedure without waiting for arrival of a staff of a game arcade. This can prevent spoilage of a game.

### SUMMARY OF THE INVENTION

However, although the gaming machine disclosed in the above-mentioned documents can reduce a degree of reduction in fun of a game, it cannot completely eliminate the reduction. Even though a tax payment procedure can be taken swiftly, the tax payment procedure which is in itself an incoherent operation still interrupts a game and inevitably reduces fun.

In addition, in the vicinity of a threshold amount at which tax obligation occurs, an actual amount a player can obtain may greatly changes. Assuming for example that in a certain region a player who wins a payout equal to or larger than a threshold amount of 1200 dollars is obliged to pay 30% of the payout, an actual amount of payout the player can obtain greatly differs between when he/she wins a payout of 1199 dollars and when he/she wins a payout of 1200 dollars. To be specific, when a player wins a payout of 1199 dollars, he/she can obtain all of the 1199 dollars, because the payout does not reach the threshold amount of 1200 dollars and no tax obligation occurs. However, when a player wins a payout of 1200 dollars, he/she can obtain only 840 dollars, because 30% of the 1200 dollars which should be paid as a tax is deducted from the 1200 dollars. Such a great difference in payment amount, in addition to a troublesome procedure of tax payment, makes the player feel very unfair and greatly spoils fun of a game. Such a situation becomes more significant particularly when a payment amount is equal to or a little higher than a threshold amount.

An object of the present invention is to provide a gaming machine and a game system which can prevent fun of a game from being spoiled by tax payment for a payout obtained.

According to a first aspect of the present invention, there is provided a gaming machine comprising a receiving unit, a lottery unit, a display unit, a payout unit, a first determination unit, a selection unit, and a bonus game execution unit. The receiving unit receives a game medium. The lottery unit holds a lottery of a win. The display unit displays thereon a result of a lottery held by the lottery unit. The payout unit gives a payout to a player. The first determination unit determines whether or not a payout number based on the result of the lottery is equal to or more than a threshold amount at which tax obligation occurs. The selection unit selects, based on an input made by the player, whether or not to execute a bonus game which gives the player an opportunity for profit, when the first determination unit determines that the payout number is equal to or more than the threshold amount. The bonus game execution unit executes the bonus game when the selection unit selects to execute the bonus game.

In the first aspect, when the first determination unit determines that the payout number is equal to or more than the threshold amount, the player can select whether or not to execute the bonus game. Accordingly, even when the player wins a payout equal to or more than the threshold amount and therefore a tax payment occurs, the player can get an opportunity for profit by executing the bonus game. Thus, an amount actually paid to the player after tax payment can be prevented from becoming too smaller than the threshold amount. That is, a variation of an amount actually paid to the player, which occurs when a payout won is in the vicinity of the threshold amount, can be reduced. This can prevent fun of a game from being spoiled by tax payment.

According a second aspect of the present invention, there is provided a game system including a gaming machine and a server that is connected to the gaming machine so as to allow two-way communication therebetween. The gaming machine comprises a receiving unit, a lottery unit, a display unit, a payout unit, a first determination unit, a selection unit, and a bonus game execution unit. The receiving unit receives a game medium. The lottery unit holds a lottery of a win. The display unit displays thereon a result of a lottery held by the lottery unit. The payout unit gives a payout to a player. The first determination unit determines whether or not a payout number based on the result of the lottery is equal to or more than a threshold amount at which tax obligation occurs. The selection unit selects, based on an input made by the player, whether or not to execute a bonus game which gives the player an opportunity for profit, when the first determination unit determines that the payout number is equal to or more than the threshold amount. The a bonus game execution unit executes the bonus game when the selection unit selects to execute the bonus game. The game system comprises an accumulating unit, an accumulated payout lottery unit, and a payout commanding unit. Every time a game is played in the gaming machine, the accumulating unit accumulates a predetermined amount. The accumulated payout lottery unit holds a lottery of whether or not to pay out an amount accumulated by the accumulating unit. The payout commanding unit commands, based on a result of a lottery held by the accumulated payout lottery unit, that the payout unit pay out an amount accumulated by the accumulating unit.

In the second aspect, the player is given an opportunity for obtaining the amount accumulated by the accumulating unit. This can enhance fun of the game because the player can expect a large amount of payout.

### BRIEF DESCRIPTION OF THE DRAWINGS

Other and further objects, features and advantages of the invention will appear more fully from the following description taken in connection with the accompanying drawings in which:

FIG. 1 is an external perspective view of a slot machine according to an embodiment of a gaming machine of the present invention;

FIG. 2 schematically shows columns of symbols that are put on outer surfaces of reels;

FIG. 3 is a block diagram showing a control system of the slot machine;

FIG. 4 is a block diagram showing a game system including slot machines and a server:

FIG. 5 is a flowchart showing a main processing that is executed by the slot machine;

FIG. 6 is a flowchart showing a main game processing that is executed by the slot machine;

FIG. 7 is a table showing winning combinations, probabilities of the respective winning combinations, and payout numbers for the respective winning combinations;

FIG. 8 is a flowchart showing a control processing executed by the server;

FIG. 9 is a flowchart showing a basic double-up game processing that is executed in S19 of FIG. 6;

FIGS. 10 and 11 are views each illustrating a lower display panel while the basic double-up game processing is executed;

FIG. 12 is a flowchart showing a bonus double-up game processing that is executed in S21 of FIG. 6; and

FIGS. 13, 14, and 15 are views each illustrating the lower display panel while the bonus double-up game processing is executed.

### DESCRIPTION OF THE PREFERRED EMBODIMENTS

In the following, a certain preferred embodiment of the present invention will be described with reference to the accompanying drawings.

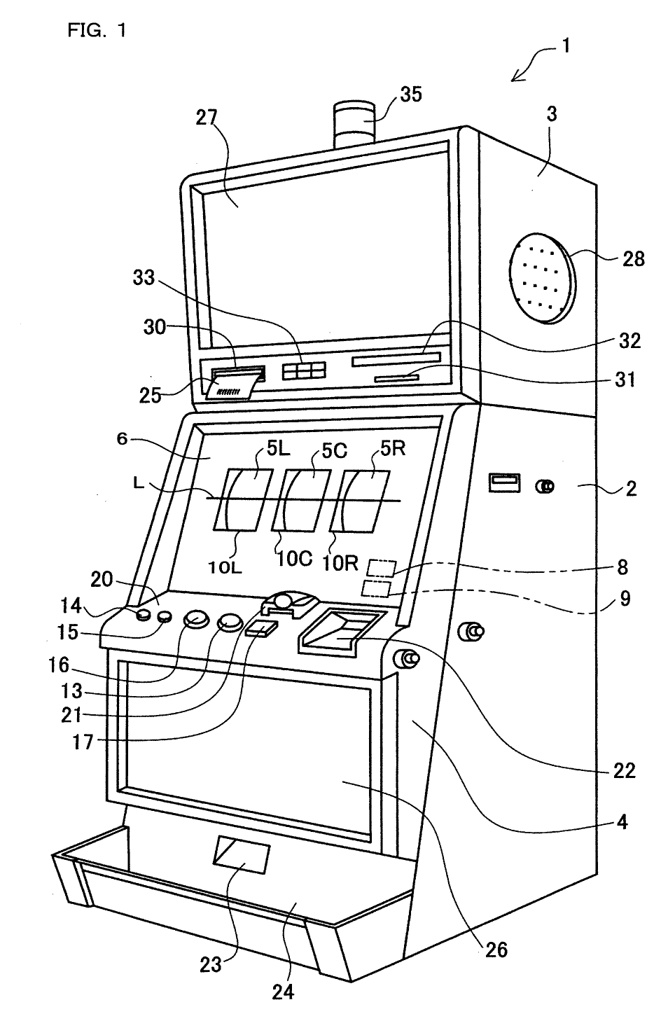

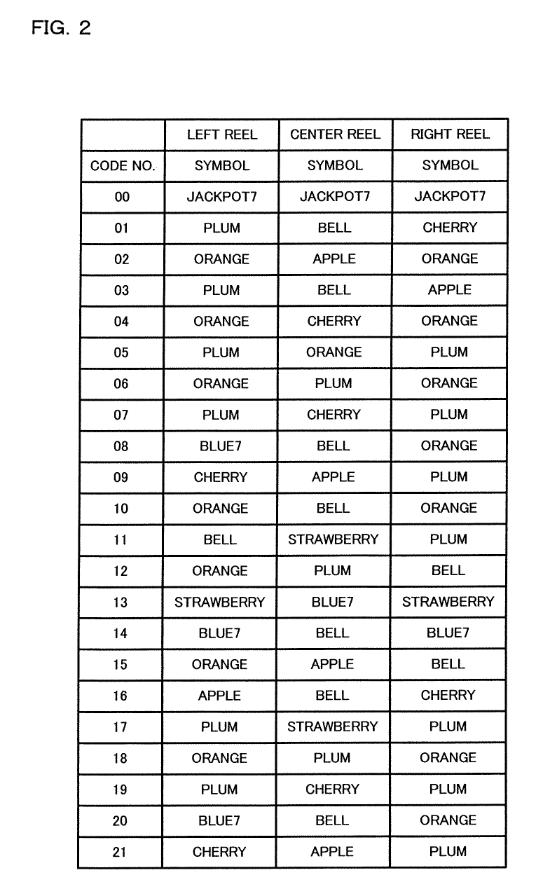

As shown in FIG. 1, a slot machine 1, which is a gaming machine according to an embodiment of the present invention, includes a cabinet 2, a top box 3 placed on the cabinet 2, and a main door 4 provided on a front face of the cabinet 2. Inside the cabinet 2, three rotatable reels 5L, 5C, and 5R are provided. A column of symbols, which includes twenty-two symbols (see FIG. 2), is painted on an outer surface of each of the reels 5L, 5C, and 5R.

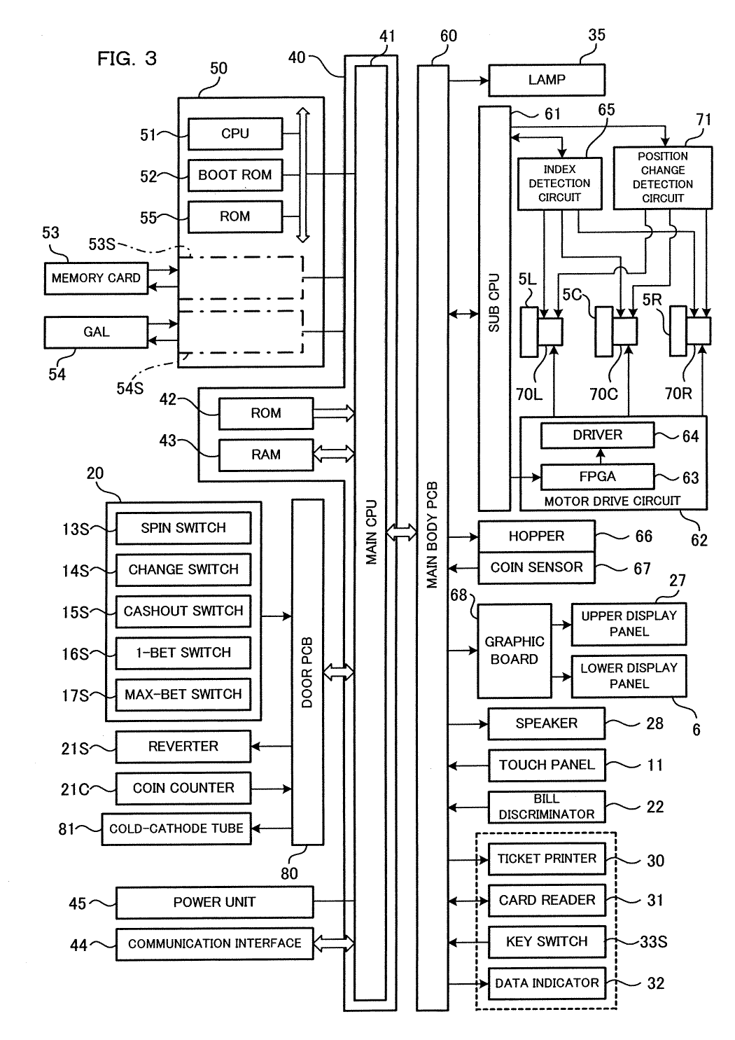

On the main door 4, a lower display panel 6 is provided in front of the reels 5L, 5C, and 5R. The lower display panel 6 has a transparent liquid crystal panel, and displays thereon various information about a game, effect images, and the like during a game. The lower display panel 6 has, on its front face, a touch panel 11 (see FIG. 3). A player inputs various commands by touching the touch panel 11. In a basic double-up game and a bonus double-up game which will be described later, an operation is made through a touch to the touch panel 11.

The lower display panel 6 has a credit value indicator 8 and a payout number indicator 9. In the credit value indicator 8, a credit value a player currently holds is indicated. In the payout number indicator 9, a payout number which will be given on condition that a predetermined combination of symbols is stopped on a pay line L is indicated.

Three transparent display windows 10L, 10C, and 10R are formed in the lower display panel 6. Three of the symbols painted on the outer surface of each of the reels 5L, 5C, and 5R can be seen through each of the display windows 10L, 10C, and 10R. One pay line L is formed on the lower display panel 6. The pay line L horizontally extends across the display windows 10L, 10C, and 10R. The pay line L defines symbols that are involved in determination of winning. When a predetermined combination of symbols is stopped on the pay line L, a payout corresponding to the combination and to a betted credit value, i.e., a bet value, is given.

A control panel 20, a coin insertion slot 21, and a bill discriminator 22 are provided on a lower side of the lower display panel 6. The control panel 20 has buttons for a player to press in order to input commands concerning a game progress. Through the coin insertion slot 21, a coin, which functions as a game medium, is inserted into the cabinet 2.

A SPIN button 13, an EXCHANGE button 14, a CASHOUT button 15, a 1-BET button 16, and a MAX-BET button 17 are provided on the control panel 20. The SPIN button 13 is pressed for inputting a command to start rotation of the reels 5L, 5C, and 5R. The EXCHANGE button 14 is pressed for asking a staff of a game arcade for an exchange. The CASHOUT button 15 is pressed for inputting a command to pay out coins, the number of which is equivalent to a credit value a player holds, through a coin payout opening 23 into a coin tray 24, or for inputting a command to issue a later-described barcoded ticket 25. Here, one credit is equivalent to one coin. The 1-BET button 16 is pressed for inputting a command to bet one credit on a game. The MAX-BET button 17 is pressed for inputting a command to bet on a game a maximum credit value bettable on one game. In this embodiment, the maximum credit value bettable on one game is 50 credits.

A reverter 21S and a coin counter 21C (see FIG. 3) are provided inside the coin insertion slot 21. The reverter 21S determines whether a coin inserted into the coin insertion slot 21 is proper one or not. Any coin different from a proper coin is ejected from the coin payout opening 23. The coin counter 21C detects a proper coin thus admitted, and counts the number of the coins.

The bill discriminator 22 determines whether a bill or a barcoded ticket 25 is proper one or not, and receives proper one into the cabinet 2. The bill inserted into the cabinet 2 is converted into coins, and a credit equivalent to the number of coins thus converted is added to the credit value a player holds. A belly glass 26 on which a character of the slot machine 1 is painted is provided on a lower part of the front face of the main door 4, that is, provided below the control panel 20.

An upper display panel 27 having a liquid crystal panel is provided on a front face of the top box 3. Displayed on the upper display panel 27 are, for example, game information including an accumulated jackpot amount, game contents, game rules, and the like. A speaker 28 that outputs a sound is provided on each side face of the top box 3.

A ticket printer 30, a card reader 31, a data indicator 32, and a keypad 33 are provided on a lower side of the upper display panel 27.

The ticket printer 30 is a printing device that prints on a ticket a barcode showing, in a coded form, data such as a credit value, time and date, and an identification number of the slot machine 1, and outputs a barcoded ticket 25 thus printed. A player makes another gaming machine read the barcoded ticket 25 thus outputted, to play a game in the gaming machine. Also, a player uses the barcoded ticket 25 when performing a procedure at a predetermined section of the game arcade.

The card reader 31 reads data out of a smart card carried by a player, and/or writes data into the smart card. Stored in the smart card are history data of games a player has played, and the like.

The data indicator 32 is formed of a fluorescent display or the like. For example, data read out by the card reader 31, data inputted by a player through the keypad 33, or the like are indicated on the data indicator 32. The keypad 33 is operated for inputting data or a command about issue of the barcoded ticket 25.

A lamp 35 is provided on an upper face of the top box 3. When an error occurs in the slot machine 1 or when calling a staff of a game arcade, the lamp 35 lights in a predetermined lighting pattern.

Subsequently, based on FIG. 2, a description will be given to symbols painted on the outer surfaces of the respective reels 5L, 5C, 5R, which are, during a game, variably displayed in a scrolling manner through the display windows 10L, 10C, and 10R of the lower display panel 6.

A column of symbols painted on the outer surface of each of the left reel 5L, the center reel 5C, and the right reel 5R is a combination of symbols of “JACKPOT 7”, “BLUE 7”, “BELL”, “CHERRY”, “STRAWBERRY”, “PLUM”, “ORANGE”, and “APPLE”. On the surface of each of the reels 5L, 5C, and 5R, predetermined symbols are arranged in a predetermined order.

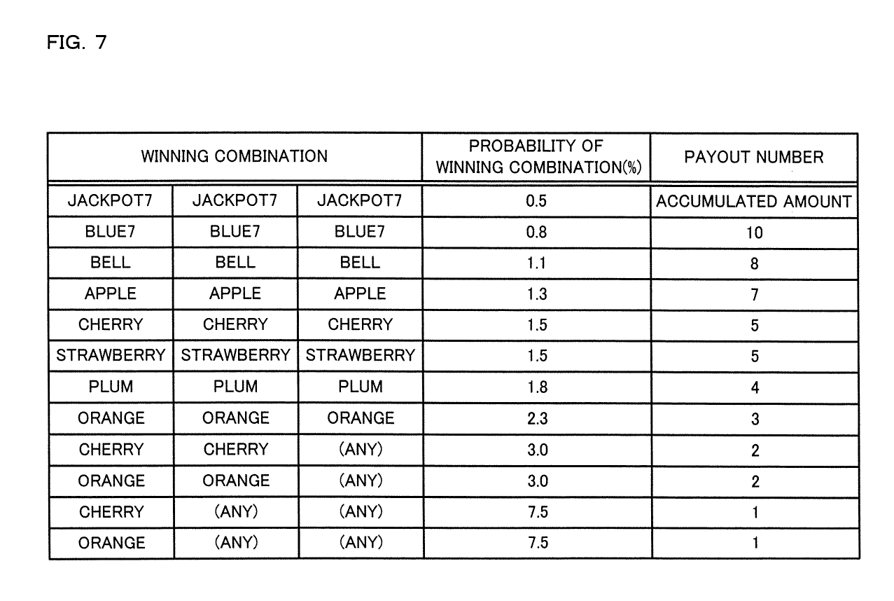

As shown in FIG. 7, when three “BLUE 7” symbols, three “BELL” symbols, three “APPLE” symbols, three “CHERRY” symbols, three “STRAWBERRY” symbols, three “PLUM” symbols, or three “ORANGE” symbols are stopped on the pay line L, a predetermined payout is given to a player. When one or two “CHERRY” or “ORANGE” symbols are stopped on the pay line L, a predetermined payout is given to a player in accordance with the number of “CHERRY” or “ORANGE” symbols stopped.

A game system 105 of this embodiment has a so-called progressive system. According to the progressive system, in each of the slot machines 1 included in the game system 105, a part, e.g., 1%, of coins betted on a game is accumulated, and the slot machine 1 that satisfies predetermined conditions is commanded to set the accumulated amount as a payout number. One of the predetermined conditions is to win a “JACKPOT”. That is, when three “JACKPOT 7” symbols are stopped on the pay line L, the amount accumulated up to that point is set as a payout number.

When the 1-BET button 16 or the MAX-BET button 17 is pressed to fix a bet value and then the SPIN button 13 is pressed, the columns of symbols painted on the reels 5L, 5C, and 5R as shown in FIG. 2 are, along with rotation of the reels 5L, 5C, 5R, displayed scrollingly from up to down within the display windows 10L, 10C, and 10R, respectively. After a predetermined period of time elapses, the reels 5L, 5C, and 5R stop rotating. As rotation of the reels 5L, 5C, and 5R stops, the columns of symbols are stopped in the display windows 10L, 10C, and 10R, respectively. Various wins have been set in advance based on combinations of symbols (see FIG. 7). When a combination of symbols that corresponds to a win is stopped on the pay line L, a payout associated with the win is given to a player.

Next, a control system of the slot machine 1 will be described with reference to FIG. 3.

As shown in FIG. 3, the control system of the slot machine 1 has a mother board 40 and a gaming board 50. The gaming board 50 includes a CPU 51, a ROM 55, a boot ROM 52, a card slot 53S, and an IC socket 54S. The CPU 51, the ROM 55, and the boot ROM 52 are connected with each other via an internal bus. A memory card 53 can be inserted into and pulled out of the card slot 53S. A GAL (General Array Logic) 54 can be inserted into and pulled out of the IC socket 54S.

The memory card 53 is a non-volatile memory, and a recording medium in which a game program and a game system program are stored. The game program includes a lottery program which is a program for determining a code number associated with a symbol which will be stopped on the pay line L. The lottery program includes symbol weighting data, which correspond to respective payout rates such as 80%, 84%, and 88%. The symbol weighting data indicate, with respect to each of the three reels 5L, 5C, and 5R, a correspondence between a code number of a symbol (see FIG. 2) and one or more random numbers belonging to a predetermined number range. That is, a code number of one symbol corresponds to one or more random numbers. A random number is sampled by a lottery, to determine which symbol will be stopped. A payout rate is determined based on payout rate setting data which is outputted from the GAL 54. A lottery is held based on the symbol weighting data corresponding to the payout rate.

The card slot 53S is connected to the mother board 40 via an IDE bus. By rewriting a game program and a game system program stored in the memory card 53, a kind of game or contents of a game playable in the slot machine 1 can be changed. Alternatively, it is also possible to prepare several memory cards 53 in which different game programs and different game system programs are stored in order that a kind of game or contents of a game playable in the slot machine 1 can be changed by replacing one memory card 53 with another memory card 53.

The game program includes a program concerning a game progress, image data and sound data which are outputted during a game, image data and sound data which work as notification data, and the like.

The GAL 54 is a kind of PLD (Programmable Logic Device) having a fixed-OR logic array. The GAL 54 has input ports and output ports. When predetermined data is inputted into the input ports, the GAL 54 outputs from the output ports data corresponding to the inputted data. The above-mentioned payout rate setting data is outputted from the output ports.

The IC socket 54S is connected to the mother board 40 via a PCI bus. By rewriting a program stored in the GAL 54 or replacing a GAL 54 itself, the payout rate setting data can be changed.

The CPU 51, the ROM 55, and the boot ROM 52 are connected to the mother board 40 via the PCI bus. The PCI bus carries a signal between the mother board 40 and the gaming board 50, and besides supplies power from the mother board 40 to the gaming board 50. Country identification information and an authentication program are stored in the ROM 55. A preliminary authentication program, a program for the CPU 51 to boot up the preliminary authentication program, which means a boot code, and the like are stored in the boot ROM 52.

The authentication program is a program for authenticating a game program and a game system program. That is, the authentication program is a falsification check program. The authentication program is written along a procedure of falsification check on a target game program and a target game system program. The preliminary authentication program is a program for authenticating the authentication program. The preliminary authentication program is written along a procedure of falsification check on a target authentication program.

The mother board 40 is a general-purpose mother board on the market, that is, a printed wiring board mounted with basic components of a personal computer. The mother board 40 has a main CPU 41, a ROM 42, a RAM 43, and a communication interface 44.

The ROM 42 is a memory device such as a flash memory. A program such as a BIOS, which is executed by the main CPU 41, and permanent data are stored in the ROM 42. When the main CPU 41 executes the BIOS, predetermined peripheral units are subjected to an initialization process, and capturing of a game program and a game system program that are stored in the memory card 53 is started via the gaming board 50.

Data and a program, which are used when the main CPU 41 operates, are stored in the RAM 43. To be more specific, stored in the RAM 43 are various programs including an authentication program, a game program, and a game system program which are read out of the gaming board 50, and various information such as a credit value a player currently holds.

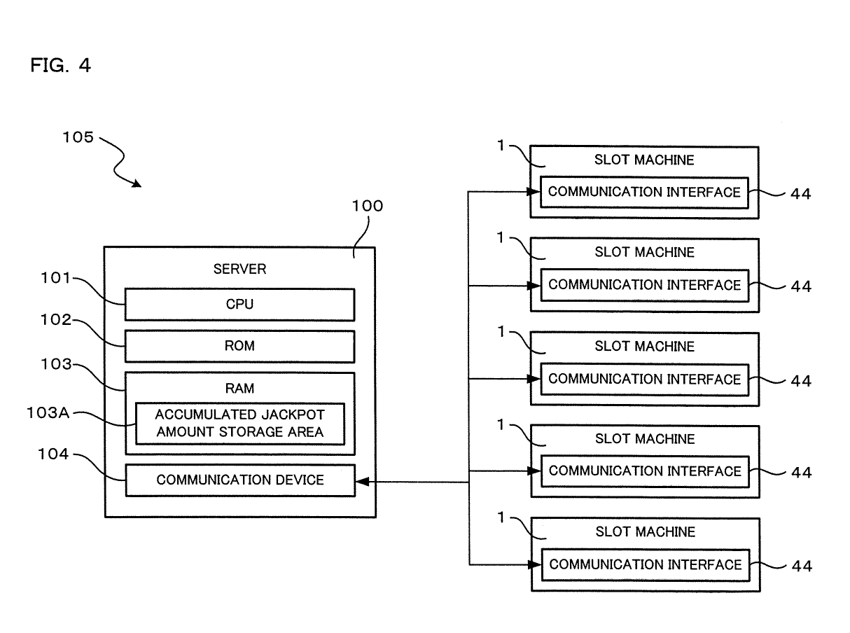

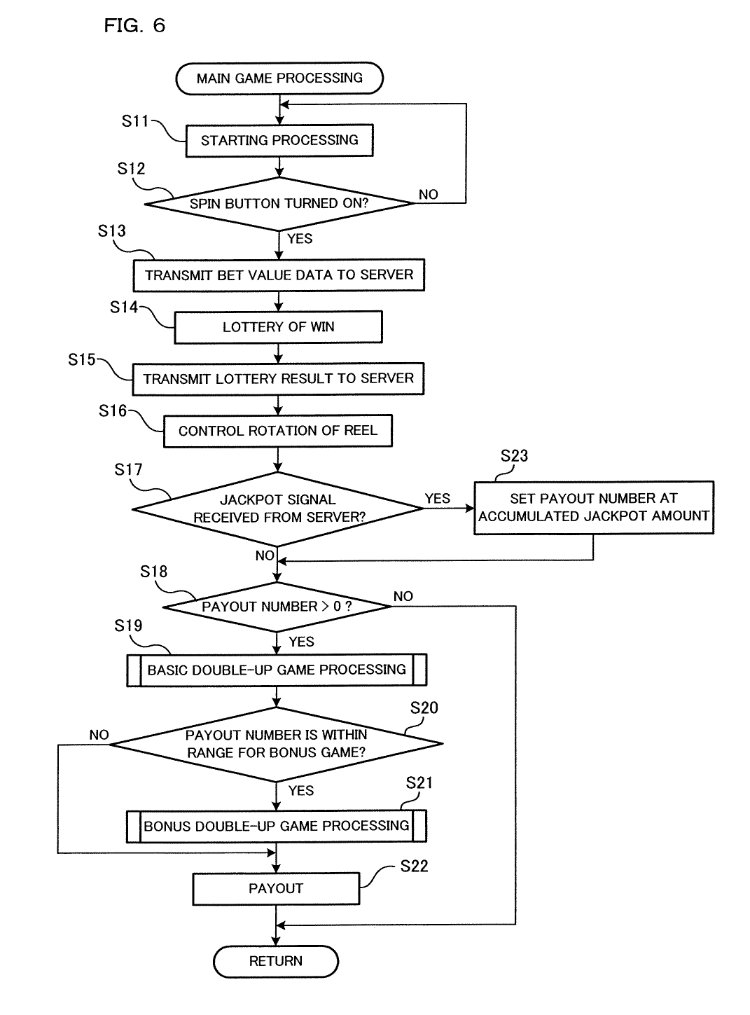

The communication interface 44 communicates with a server 100 (see FIG. 4) placed in the game arcade. For example, in a main game processing (see FIG. 6), the communication interface 44 is used for transmitting bet value data to the server 100 (S13), transmitting data about a lottery result to the server 100 (S15), or the like.

A main body PCB 60 and a door PCB 80 are respectively connected to the mother board 40 via USBs. A power unit 45 is also connected to the mother board 40. When power is supplied from the power unit 45 to the mother board 40, the main CPU 41 of the mother board 40 is started, and power is supplied through the PCI bus to the gaming board 50 so that the CPU 51 is started.

Equipments or devices that generate an input signal to be inputted to the main CPU 41, and equipments or devices whose operations are controlled in accordance with a control signal from the main CPU 41 are connected to the main body PCB 60 and the door PCB 80, respectively. Based on an input signal inputted into the main CPU 41, the main CPU 41 executes a game program and a game system program stored in the RAM 43. Then, the main CPU 41 executes a predetermined computing processing, and stores a result of the processing into the RAM 43, or transmits a control signal to the equipments or devices.

The lamp 35, a sub CPU 61, a hopper 66, a coin sensor 67, a graphic board 68, the speaker 28, the touch panel 11, the bill discriminator 22, the ticket printer 30, the card reader 31, a key switch 33S, and the data indicator 32 are connected to the main body PCB 60.

The sub CPU 61 controls rotating and stopping of the reels 5L, 5C, and 5R. A motor drive circuit 62 including an FPGA (Field Programmable Gate Array) 63 and the driver 64 is connected to the sub CPU 61. The FPGA 63 is an electronic circuit such as an LSI (Large Scale Integration) capable of programming. The FPGA 63 functions as a control circuit for stepping motors 70L, 70C, and 70R. The driver 64 functions as an amplifier circuit for a pulse which will be inputted into the stepping motors 70L, 70C, and 70R. The stepping motors 70L, 70C, and 70R are connected to the motor drive circuit 62. The stepping motors 70L, 70C, and 70R are for rotating the respective reels 5L, 5C, and 5R. The stepping motors 70L, 70C, and 70R are stepping motors of 1-2 phase excitation type.

An index detection circuit 65 and a position change detection circuit 71 are connected to the sub CPU 61. The index detection circuit 65, which detects a position, e.g., a reference point, of the rotating reels 5L, 5C, and 5R, can detect out-of-step of the reels 5L, 5C, and 5R.

The position change detection circuit 71 detects a change of a stopping position of the reels 5L, 5C, and 5R after rotation of the reels 5L, 5C, and 5R is stopped. For example, in a case where a winning combination of symbols is actually not made but nevertheless a player forcibly changes a stopping position so as to make a winning combination of symbols, the position change detection circuit 71 detects a change of a stopping position of the reels 5L, 5C, and 5R.

The hopper 66 is placed within the cabinet 2, and pays out a predetermined number of coins through the coin payout opening 23 into the coin tray 24 based on a control signal from the main CPU 41. The coin sensor 67 is provided inside the coin payout opening 23, and outputs an input signal into the main CPU 41 when detecting a predetermined number of coins being paid out through the coin payout opening 23.

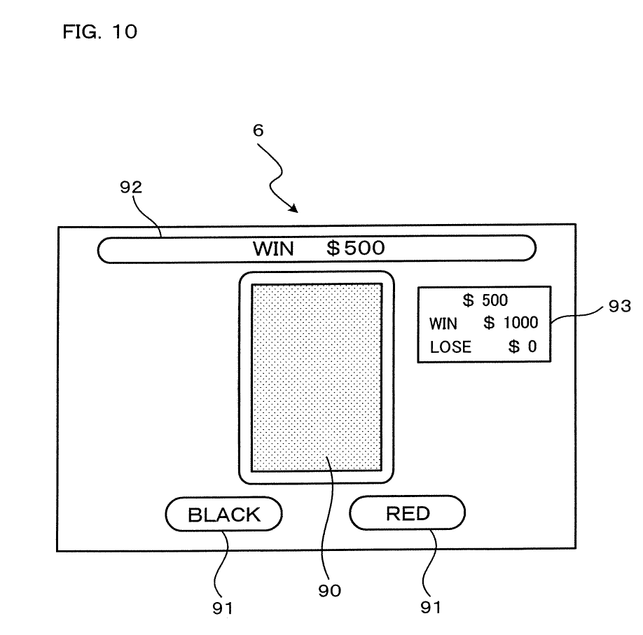

The graphic board 68 controls an image display on the upper display panel 27 and the lower display panel 6, based on a control signal from the main CPU 41. For example, the credit value indicator 8 indicates a credit value a player holds, which is stored in the RAM 43. The payout number indicator 9 indicates a payout number. The graphic board 68 has a VDP (Video Display Processor), a video RAM, and the like. The VDP generates image data based on a control signal from the main CPU 41 by using data in a game program that has been stored in the RAM 43. Image data generated by the VDP is temporarily stored in the video RAM. When the basic double-up game processing (S19) or the bonus double-up game processing (S21) is executed, the graphic board 68 controls the lower display panel 6 so that a double-up game screen (see FIGS. 10, 11, and 13 to 15) is displayed.

When admitting a proper bill or a proper barcoded ticket 25, the bill discriminator 22 outputs an input signal to the main CPU 41 based on the amount of the bill or based on the number of coins recorded on the barcoded ticket 25.

Based on a control signal from the main CPU 41, the ticket printer 30 prints on a ticket a barcode showing, in a coded form, data such as a credit value stored in the RAM 43, and outputs a barcoded ticket 25 thus printed. The card reader 31 reads data out of a smart card and transmits the data to the main CPU 41, or writes data into a smart card based on a control signal from the main CPU 41. The key switch 33S is provided in the keypad 33. When the keypad 33 is operated by a player, the key switch 33S outputs a predetermined input signal to the main CPU 41. Based on a control signal outputted from the main CPU 41, the data indicator 32 indicates data read out by the card reader 31, data inputted by a player using the keypad 33, or the like.

The control panel 20, the reverter 21S, the coin counter 21C, and a cold-cathode tube 81 are connected to the door PCB 80. The control panel 20 includes a SPIN switch 13S provided within the SPIN button 13, an EXCHANGE switch 14S provided within the EXCHANGE button 14, a CASHOUT switch 15S provided within the CASHOUT button 15, a 1-BET switch 16S provided within the 1-BET button 16, and a MAX-BET switch 17S provided within the MAX-BET button 17. When a button corresponding to each switch is pressed by a player, the switch outputs an input signal to the main CPU 41.

When detecting a proper coin, the coin counter 21C outputs an input signal to the main CPU 41. The reverter 21S operates based on a control signal outputted from the main CPU 41. The reverter 21S distributes a coin, which has been determined as proper by the coin counter 21C, to a cash box (not shown) provided in the slot machine 1 or to the hopper 66. The cold-cathode tube 81 is provided on a back side of the lower display panel 6 and the upper display panel 27. The cold-cathode tube 81 is lighted based on a control signal from the main CPU 41, and functions as a backlight.

As shown in FIG. 4, the slot machine 1 is connected via the communication interface 44 to the server 100 which is placed in a game arcade, so as to allow two-way communication therebetween. The game system 105 is made up of five slot machines 1 and the server 100. Each of the five slot machines 1 has the above-described construction.

The server 100 has a CPU 101, a ROM 102, a RAM 103, and a communication device 104. The CPU 101 is a processing unit that executes control programs stored in the ROM 102 and performs predetermined computing processings based on the programs. The ROM 102 stores therein a control processing program which will be described later.

The RAM 103 is a storage device in which a result of computation by the CPU 101 is temporarily stored. An accumulated jackpot amount storage area 103A is formed in the RAM 103. Every time any of the five slot machines 1 transmits bet value data to the server 100, 1% of an amount indicated by the bet value data is accumulated in the accumulated jackpot amount storage area 103A. When a slot machine 1 satisfies a predetermined condition such as making the “JACKPOT” combination, the CPU 101 commands the slot machine 1 to set a payout number at an accumulated jackpot amount that is stored in the accumulated jackpot amount storage area 103A.

The communication device 104 is connected to the communication interface 44 of each slot machine 1 so as to allow two-way communication therebetween. The communication device 104 is used for receiving data such as bet value data and a lottery result via the communication interface 44, for transmitting a jackpot winning signal to the slot machine 1 that satisfies a predetermined condition, and the like.

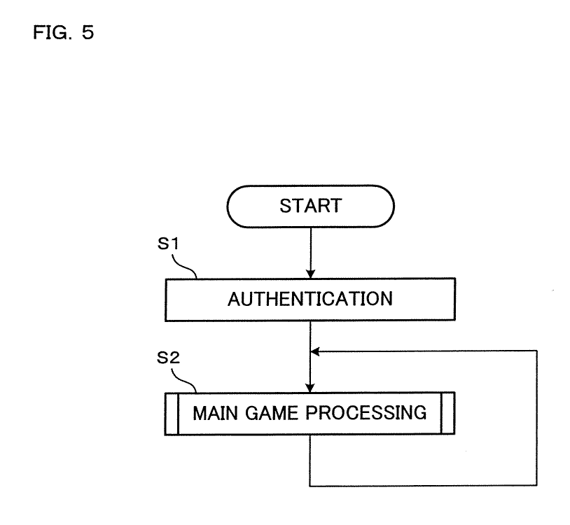

Next, a main processing that is executed by the slot machine 1 will be described with reference to FIG. 5. It is presupposed that, in the slot machine 1, the memory card 53 has already been inserted into the card slot 53S of the gaming board 50 and the GAL 54 has already been mounted to the IC socket 54S. Programs shown in FIGS. 5, 6, 9, and 12 are stored in the ROM 42 or the RAM 43 of the slot machine 1, and executed by the main CPU 41.

First, when the power unit 45 is powered up, the mother board 40 and the gaming board 50 are booted up, and authentication is performed individually in the mother board 40 and in the gaming board 50 (S1). To be more specific, in the gaming board, the CPU 51 reads out the preliminary authentication program that is stored in the boot ROM 52. In accordance with the preliminary authentication program, the CPU 51 authenticates that the authentication program is not falsified, before the mother board 40 reads out the authentication program. In the mother board 40, the main CPU 41 executes the BIOS that is stored in the ROM 42, and expands in the RAM 43 compressed data included in the BIOS. The main CPU 41 executes the BIOS thus expanded in the RAM 43. The main CPU 41 also checks and initializes various peripheral units. Then, the main CPU 41 reads out the authentication program stored in the ROM 55, and authenticates that a game program and a game system program stored in the memory card 53 that is inserted into the card slot 53S are not falsified. When authentication is completed normally, the main CPU 41 stores into the RAM 43 the game program and the game system program thus authenticated, and also stores into the RAM 43 country identification information stored in the ROM 55 and payout rate setting data outputted from the GAL 54.

Then, the main CPU 41 sequentially reads out of the RAM 43 the game program and the game system program authenticated in S1. The main CPU 41 executes these programs, to execute a main game processing (S2). By executing the main game processing, a game is played in the slot machine 1. The main game processing is executed repeatedly as long as the slot machine 1 is supplied with power.

Next, a main game processing (S2) of FIG. 5 will be described with reference to FIG. 6.

First, the main CPU 41 executes a predetermined initial setting. Then, based on insertion of a coin or pressing of the 1-BET button 16 or the MAX-BET button 17, the main CPU 41 executes a starting processing in which a bet value betted on the pay line L is determined (S11).

Then, the main CPU 41 determines whether the SPIN button 13 is turned ON or not, based on whether an input signal is received from the SPIN switch 13S or not (S12). When the SPIN button 13 is not turned ON (S12: NO), the processing returns to S11. In this case, a bet value can be changed. When the SPIN button 13 is turned ON (S12: YES), the main CPU 41 subtracts from the current credit value a bet value that is based on the pressing of the 1-BET button 16 or the MAX-BET button 17. Then, the main CPU 41 stores the bet value data into the RAM 43.

Subsequently, the main CPU 41 reads out the bet value data from the RAM 43, and then transmits the bet value data to the server 100 via the communication interface 44 (S13). The bet value data transmitted from the respective slot machines 1 are used for calculating the accumulated jackpot amount. This will be described in detail later.

After S13, the main CPU 41 holds a lottery (S14). More specifically, the main CPU 41 executes a random number generating program that is included in the lottery program stored in the RAM 43, to thereby select, among a number range of 0 to 255, a random number corresponding to each of the reels 5L, 5C, and 5R. Then, the main CPU 41 refers to symbol weighting data corresponding to the payout rate setting data, and determines code numbers for the respective reels 5L, 5C, and 5R (see FIG. 2) based on three random numbers selected. Then, the main CPU 41 stores the code numbers into the RAM 43.

The code numbers correspond to code numbers of symbols. Accordingly, by determining code numbers for the respective reels 5L, 5C, and 5R, a combination of symbols which will be stopped on the pay line L is determined. For example, when code numbers for the respective reels 5L, 5C, and 5R are determined as “00”, “00”, and “00”, a “JACKPOT 7” combination is made (see FIG. 2).

Here, with reference to FIG. 7, a description will be given to winning combinations, probabilities of the respective winning combinations, and payout numbers for the respective winning combinations.

Payout numbers shown in FIG. 7 are under the condition that a bet value is “1”. Accordingly, when a bet value is “1”, the payout number shown in FIG. 7 is given. When a bet value is “2” or more, a value obtained by multiplying the payout number shown in FIG. 7 by the bet value is given as a payout.

Probabilities of winning combinations shown in FIG. 7 are under the condition that a payout rate is 88%. The probability of a winning combination shown in FIG. 7 indicates a probability that, when code numbers for the respective reels 5L, 5C, and 5R are determined based on three random numbers and with reference to the symbol weighting data corresponding to the payout rate of 88%, a winning combination corresponding to the code numbers will be made. That is, even when code numbers are determined, a winning combination corresponding to the code numbers is not always made.

For example, a probability of a “JACKPOT 7” win is 0.5%. When this win is made, three “JACKPOT 7” symbols are stopped on the pay line L, and the accumulated jackpot amount stored in the accumulated jackpot amount storage area 103A of the server 100 is set as a payout number.

A probability of a “BLUE 7” win is 0.8%. When this win is made, three “BLUE 7” symbols are stopped on the pay line L, and 10 credits per one bet are set as a payout number. For the other wins, probabilities and payout numbers are set as shown in FIG. 7. When a combination of symbols that is not shown in FIG. 7 is made, it means a loss and therefore a payout number is set at 0.

Referring to FIG. 6 again, in S15, the main CPU 41 transmits via the communication interface 44 to the server 100 data about a lottery result obtained in S14.

After S15, the main CPU 41 executes controlling of rotation of the reels 5L, 5C, and 5R (S16). This processing is executed by the main CPU 41 and the sub CPU 61. To be more specific on the controlling of rotation, the main CPU 41 firstly transmits to the sub CPU 61 a start signal for starting rotation of the reels 5L, 5C, and 5R. Upon receiving the start signal, the sub CPU 61 drives the stepping motors 70L, 70C, and 70R through the motor drive circuit 62 and the driver 64, so that the reels 5L, 5C, and 5R are rotated accordingly. After transmitting the start signal, the main CPU 41 determines an effect mode in a game, that is, a mode of displaying an image on the lower display panel 6 or outputting sound from the speaker 28. Then, the main CPU 41 starts presenting the effect in the determined mode. Then, at a timing for stopping the rotation of the reels 5L, 5C, and 5R, the main CPU 41 transmits to the sub CPU 61 the code numbers stored in the RAM 43. The sub CPU 61 stops the reels 5L, 5C, and 5R based on the code numbers. As a result, symbols corresponding to the lottery result obtained in S14 are stopped on the pay line L.

Then, the main CPU 41 determines whether a jackpot signal is received from the server 100 via the communication interface 44, or not (S17). The jackpot signal is a signal commanding that a payout number be set at the accumulated jackpot amount which is currently stored in the accumulated jackpot amount storage area 103A of the server 100. When a lottery of jackpot has been won in S14, or when a jackpot lottery in the server 100 has been won in S103, the jackpot signal is transmitted from the server 100. Upon receiving the jackpot signal (S17: YES), the main CPU 41 stores, as a payout number, the accumulated jackpot amount included in the signal into the RAM 43 (S23). Then, the processing proceeds to S18. Neither of the above-mentioned two conditions is satisfied, the processing just proceeds to S18 without receiving the jackpot signal (S17: NO).

In S18, the main CPU 41 determines whether a payout number currently set is more than zero or not. When the jackpot signal is received in S17, or when a win is made, the main CPU 41 determines that the payout number is more than zero (S18: YES), and the processing proceeds to S19. When the jackpot signal is not received and in addition no win is made, the main CPU 41 determines that the payout number is zero (S18: NO), and the main game processing ends.

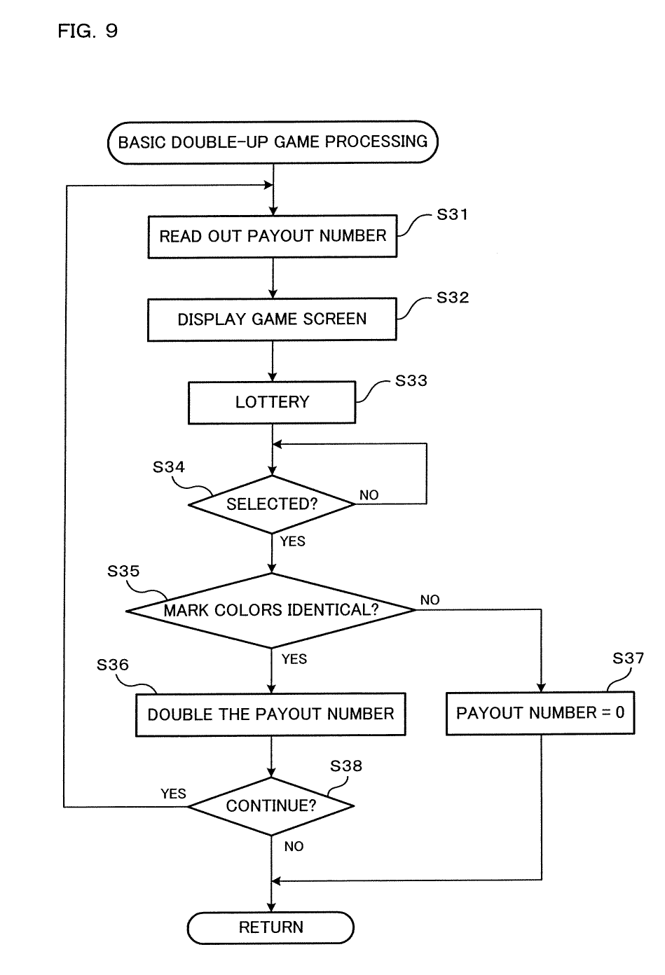

In S19, the main CPU 41 executes a basic double-up game processing. In a basic double-up game, an either-or game is played using a whole of the payout number currently set. More specifically, through the touch panel 11, one of two alternatives is selected. When a right choice is made, the payout number is doubled. When a wrong choice is made, the payout number is down to zero. The basic double-up game processing will be detailed later with reference to FIG. 9.

After S19, the main CPU 41 determines whether the payout number is within a range for a bonus game, or not (S20). The range for a bonus game means a range from an amount at which a tax obligation occurs (hereinafter referred to as a threshold amount) to less than an amount which, after tax, becomes equal to the threshold amount (hereinafter referred to as an upper limit). In this embodiment, the threshold amount is 1200 dollars. When a payout equal to or more than 1200 dollars is won, 30% of the payout should be paid as a tax. The upper limit is 1714 dollars, which is a result of {threshold amount 1200 dollars/(100%-30%)}. Accordingly, in S20, the main CPU 41 determines whether the payout number is within a range for a bonus game from 1200 dollars to less than 1714 dollars, or not.

When the payout number is within the range for a bonus game (S20: YES), a bonus double-up game processing is executed (S21). When the payout number is out of the range for a bonus game (S20: NO), a payout is made (S22).

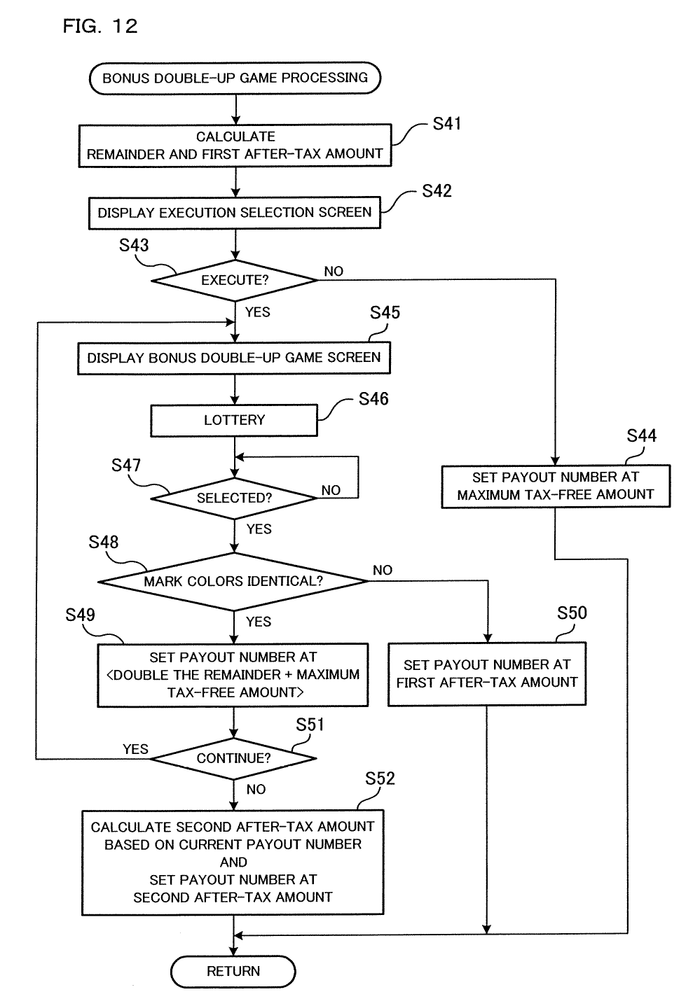

In the bonus double-up game processing S21, a bonus double-up game is played. In the bonus double-up game, a remainder left after subtracting the maximum tax-free amount from the payout amount is used as a bet amount. The maximum tax-free amount means a maximum amount less than the threshold amount. In this embodiment, the maximum tax-free amount is 1199 dollars. The bonus double-up game will be detailed later with reference to FIG. 12. After the bonus double-up game processing, the processing proceeds to S22.

In S22, the main CPU 41 actually pays out an amount that is currently set as the payout amount (S22). At this time, the CASHOUT button 15 may be pressed to pay out coins equivalent to the credit value, or alternatively a barcoded ticket 25 may be issued.

In S20, when the main CPU 41 determines that the payout number is more than the upper limit 1714 dollars (S20: NO), an amount left after subtracting a tax amount from the payout number is set as an actual payout number. Then, the amount after tax is paid out in S22.

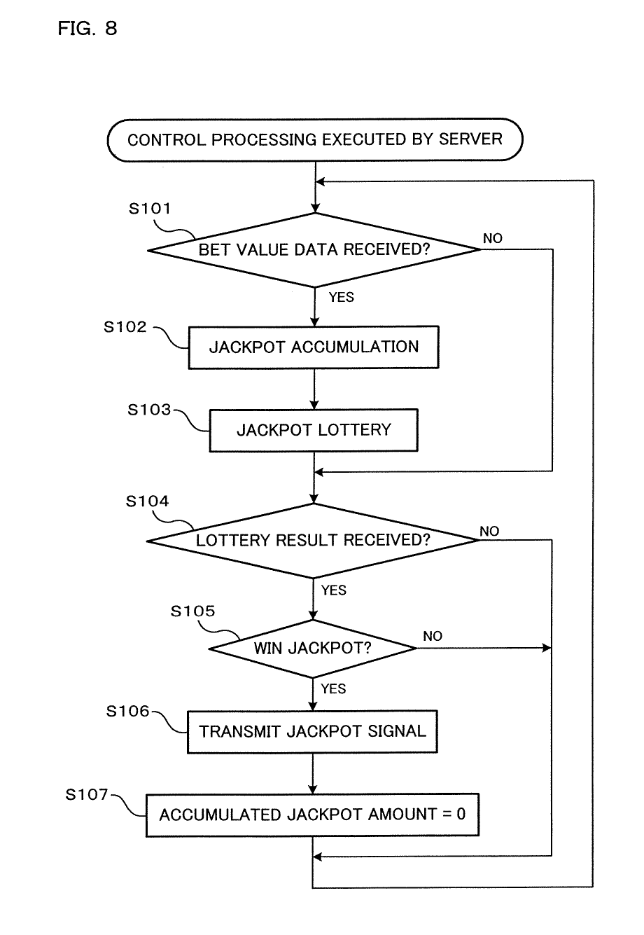

Next, a control processing executed by the server 100 will be described with reference to FIG. 8.

First, the CPU 101 determines whether bet value data are received from any slot machine 1 or not (S101). When bet value data are received (S101: YES), 1% of an amount indicated by the bet value data is accumulated in the accumulated jackpot amount storage area 103A (S102). When bet value data are not received (S101: NO), the processing proceeds to S104.

After S102, the CPU 101 holds a jackpot lottery (S103). The jackpot lottery is for determining by lottery whether or not to command the slot machine 1, which is a sender of the bet value data received in S101, to set a payout number at the accumulated jackpot amount that is stored in the accumulated jackpot amount storage area 103A. In the jackpot lottery, one random number is selected out of 0 to 511 based on a random number generating program stored in the ROM 102, and a result is determined with reference to a lottery table stored in the ROM 102. More specifically, when “0” or “1” is selected as the random number the lottery is won, and when any random number other than “0” and “1” is selected the lottery is lost. Thus, in S103, a probability of win is approximately 0.4%. The CPU 101 stores into the RAM 43 a lottery result obtained in S103, and then the processing proceeds to S104.

After S103, the CPU 101 determines whether data about a lottery result is received from the aforesaid slot machine 1 or not (S104). When the data is not received (S104: NO), the processing returns to S101. When the data is received (S104: YES), the CPU 101 determines whether a jackpot is won or not (S105).

When the aforesaid slot machine 1 makes a “JACKPOT” win in S14, or when the jackpot lottery is won in S103, the CPU 101 determines that a jackpot is won (S105: YES). Then, the CPU 101 reads out the accumulated jackpot amount from the accumulated jackpot amount storage area 103A, and transmits to the aforesaid slot machine 1 a jackpot signal that indicates winning of jackpot and the accumulated jackpot amount (S106). When the CPU 101 determines that a jackpot is not won (S105: NO), the processing returns to S101.

After S106, the CPU 101 resets the accumulated jackpot amount stored in the accumulated jackpot amount storage area 103A, to zero (S107). Then, the processing returns to S101.

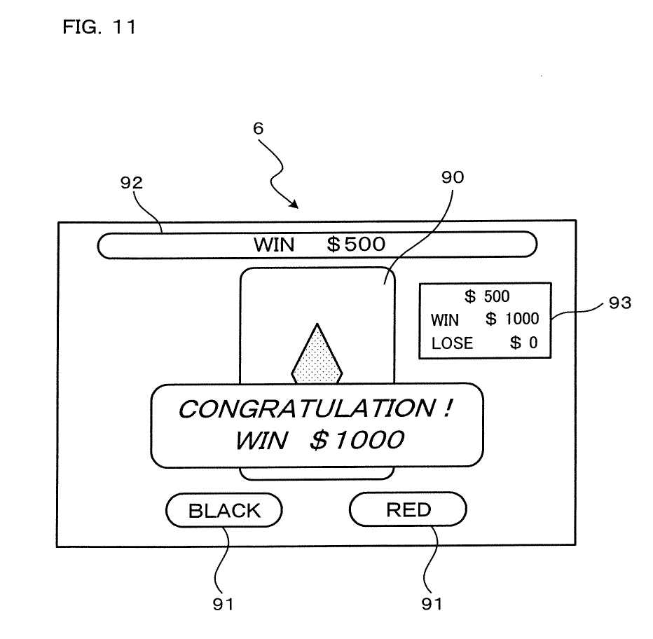

Next, the basic double-up game processing that is executed in S19 of FIG. 6 will be described with reference to FIGS. 9, 10, and 11. FIG. 9 is a flowchart showing the basic double-up game processing. FIGS. 10 and 11 are views each illustrating the lower display panel 6 while the basic double-up game processing is executed. In the basic double-up game processing, a game is played in which a color of a mark of a playing card is guessed. More specifically, a player selects whether a mark of a playing card 90 that is displayed on the lower display panel 6 is red (diamond, heart) or black (spade, club). When the player selects a correct answer, the payout number is doubled. When the player selects an incorrect answer, the payout number is down to zero.

First, the main CPU 41 reads out the current payout number from the RAM 43 (S31). In a case where the processing proceeds to the basic double-up game processing after a jackpot signal is received, the accumulated jackpot amount indicated by the jackpot signal serves as the current payout number. In a case where the processing proceeds to the basic double-up game processing without receiving a jackpot signal, a payout number corresponding to a winning combination of symbols (see FIG. 7) is read out.

Then, the main CPU 41 displays a double-up game screen on the lower display panel 6 (S32). In the following, the double-up game screen will be described in detail with reference to FIG. 10.

A playing card image 90, selection buttons 91, a payout number indicator 92, and a window 93 are shown in the double-up game screen. The selection buttons 91 indicate alternatives of “BLACK” and “RED”. The payout number indicator 92 indicates a current payout number. Shown in the window 93 are an amount betted on a game, a payout number as a result of correctly guessing a color of a mark of the playing card, and a payout number as a result of incorrectly guessing a color of a mark of the playing card. In a state shown in FIG. 10 for example, the current payout number is 500 dollars, and the payout number indicator 92 indicates 500 dollars. In the window 93, 500 dollars, 1000 dollars, and 0 dollars are shown as a bet amount, a payout number given when the game is won, a payout number given when the game is lost, respectively. At a stage of S32, a backside of the playing card image 90 is shown so that a mark is invisible.

After S32, the main CPU 41 determines by lottery a mark which will appear on a front face of the playing card image 90 (S33). More specifically, a predetermined number range within a range of 0 to 255 is set with respect to each of four marks “spade”, “diamond”, “club”, and “heart”. By determining one random number using a random number generating program, a mark which will appear on the front face of the playing card image 90 is determined. The main CPU 41 stores into the RAM 43 a lottery result thus obtained, and then the processing proceeds to S34.

In S34, the main CPU 41 determines whether a player has pressed any of the selection buttons 91 for “BLACK” and “RED” or not. When neither of the selection buttons 91 has been pressed (S34: NO), the main CPU 41 waits until the player presses any of the selection buttons 91. When either of the selection buttons 91 has been pressed (S34: YES), the main CPU 41 stores into the RAM 43 data indicating the pressed selection button 91. Then, the processing proceeds to S35.

In S35, the main CPU 41 notifies the player of the lottery result, by showing on the playing card image 90 the mark that is based on the lottery result obtained in S33. Further, the main CPU 41 reads out from the RAM 43 the lottery result obtained in S33 and a selection result obtained in S34, to determine whether the selection result obtained in S34 is identical to the lottery result obtained in S33 or not. When the selection result obtained in S34 is identical to the lottery result obtained in S33 (S35: YES), the main CPU 41 doubles a payout number and stores the doubled value into the RAM 43 (S36). Then, the main CPU 41 shows it by displaying (see FIG. 11). After S36, the processing proceeds to S38.

When the selection result obtained in S34 is not identical to the lottery result obtained in S33 (S35: NO), the main CPU 41 makes a payout number zero, and stores the value “0” into the RAM 43 (S37). Then, the main CPU 41 ends the basic double-up game processing.

In S38, based on an input made by the player, the main CPU 41 determines whether the basic double-up game continues or not. To be specific, the main CPU 41 firstly displays on the lower display panel 6 a question of whether the basic double-up game should continue or not. Then, based for example on an operation through the touch panel 11 made by the player, the main CPU 41 determines whether the basic double-up game continues or not.

When the player inputs a command to continue the basic double-up game (S38: YES), the processing returns to S31. In this case, the current payout number which means the payout number doubled in S36 is betted on a next basic double-up game. When the player inputs a command to end the basic double-up game (S38: NO), the basic double-up game processing ends.

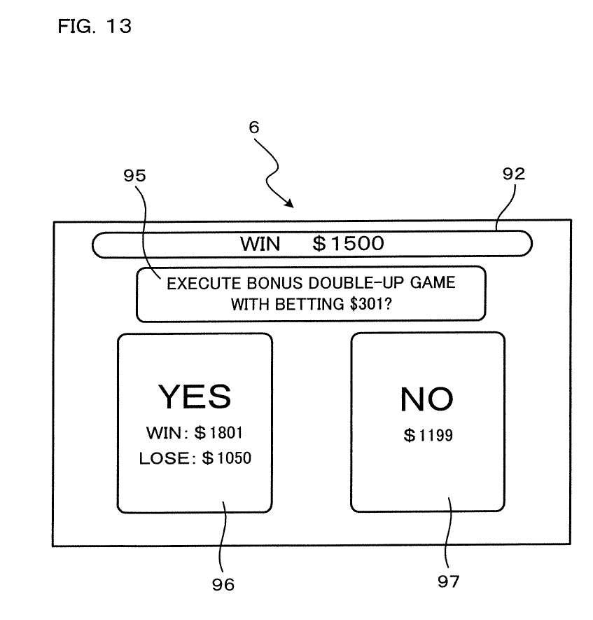

Next, a bonus double-up game processing that is executed in S21 of FIG. 6 will be described with reference to FIGS. 12, 13, 14, and 15. FIG. 12 is a flowchart showing a bonus double-up game processing. FIGS. 13 to 15 are views each illustrating the lower display panel 6 while the bonus double-up game processing is executed. In the bonus double-up game processing, like in the basic double-up game processing described above, a game is played in which a color of a mark of a playing card is guessed.

First, the main CPU 41 reads out the current payout number from the RAM 43, and calculates a remainder and a first after-tax amount (S41). The remainder is calculated by subtracting the maximum tax-free amount from the payout amount. For example, in a case where the payout amount is 1500 dollars, the remainder is 301 dollars which is left after subtracting the maximum tax-free amount 1199 dollars from the payout amount 1500 dollars. The remainder is an amount to be betted on the bonus double-up game. The first after-tax amount is calculated by subtracting, from the payout amount, an amount obtained by multiplying the payout amount by the tax rate 30%. Thus, in a case where the payout amount is 1500 dollars, the first after-tax amount is 1050 dollars which is a result of {payout amount 1500 dollars−(1500 dollars*tax rate 30%)}.

After S41, the main CPU 41 displays on the lower display panel 6 an execution selection screen shown in FIG. 13 (S42). The execution selection screen shows a payout number indicator 92, a message window 95, and selection buttons 96 and 97. The payout number indicator 92 indicates a current payout number. The message window 95 asks a player whether to execute the bonus double-up game or not. The selection buttons 96 and 97 indicate alternatives of “YES” and “NO”, respectively. In FIG. 13, the window 95 shows a message asking whether or not a bonus double-up game is executed using the remainder 301 dollars that has been calculated in S41. The selection button 96 indicates a payout number given when the bonus double-up game is won, and a payout number given when the bonus double-up game is lost. To be more specific, the payout number given when the bonus double-up game is won is 1801 dollars which is a result of adding double the remainder 602 dollars to the maximum tax-free amount 1199 dollars. The payout number given when the bonus double-up game is lost is 1050 dollars which is the same as the first after-tax amount. The selection button 97 indicates a payout number given when the bonus double-up game is not executed. The payout number given when the bonus double-up game is not executed is 1199 dollars which is the same as the maximum tax-free amount.

After S42, based on the player's pressing either selection button 96 or 97, the main CPU 41 determines whether to execute the bonus double-up game or not (S43). When the selection button 97 is pressed (S43: NO), the main CPU 41 sets a payout number at the maximum tax-free amount (S44). Then, the bonus double-up game processing ends. In this case, the maximum tax-free amount 1199 dollars is paid out to the player in S22 of FIG. 6.

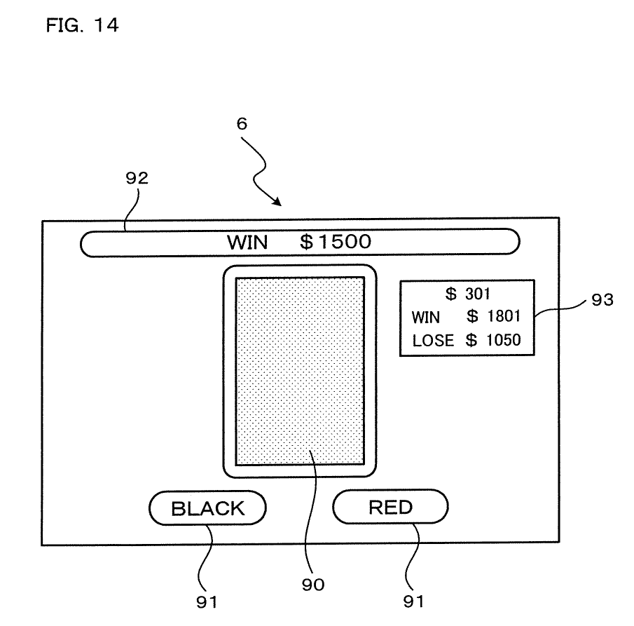

When the selection button 96 is pressed (S43: YES), the main CPU 41 displays on the lower display panel 6 a double-up game screen shown in FIG. 14 (S45). The double-up game screen is basically the same as the double-up game screen that is displayed in the above-described basic double-up game processing (see FIG. 10). However, contents shown in the window 93 are different, because the payout numbers given when the bonus double-up game is won and lost are different from the payout numbers given when the basic double-up game is won and lost. More specifically, in FIG. 14, the window 93 shows 301 dollars as an amount betted on the bonus double-up game (remainder), 1801 dollars as a payout number given when the game is won (maximum tax-free amount+double the remainder), and 1050 dollars as a payout number given when the game is lost (first after-tax amount).

After S45, the main CPU 41 determines by lottery a mark which will appear on a front face of the playing card image 90 (S46). The lottery is the same as the lottery held in the above-described basic double-up game processing (S33), and therefore a specific description thereof will be omitted.

After S46, the main CPU 41 determines whether a player has pressed any of the selection buttons 91 for “BLACK” and “RED” or not (S47). When neither of the selection buttons 91 has been pressed (S47: NO), the main CPU 41 waits until the player presses any of the selection buttons 91. When either of the selection buttons 91 has been pressed (S47: YES), the main CPU 41 stores into the RAM 43 data indicating the pressed selection button 91. Then, the processing proceeds to S48.

In S48, the main CPU 41 notifies the player of the lottery result, by showing on the playing card image 90 the mark that is based on the lottery result obtained in S46. Further, the main CPU 41 reads out from the RAM the lottery result obtained in S46 and a selection result obtained in S47, to determine whether the selection result obtained in S47 is identical to the lottery result obtained in S46 or not. When the selection result obtained in S47 is identical to the lottery result obtained in S46 (S48: YES), the main CPU 41 sets a payout number at 1801 dollars which is a result of adding double the remainder 301 dollars to the maximum tax-free amount 1199 dollars (S49). Then, the processing proceeds to S51.

When the selection result obtained in S47 is not identical to the lottery result obtained in S46 (S48: NO), the main CPU 41 sets a payout number at 1050 dollars which is the same amount as the first after-tax amount (S50). Then, the main CPU 41 ends the bonus double-up game processing. In this case, therefore, the first after-tax amount, which is an amount after a tax is paid on the payout number set at an end of the basic double-up game processing (S19), is paid out in S22 of FIG. 6. For example, even though several bonus double-up games are played but none of the games are won, it is still ensured that the first after-tax amount will be paid out.

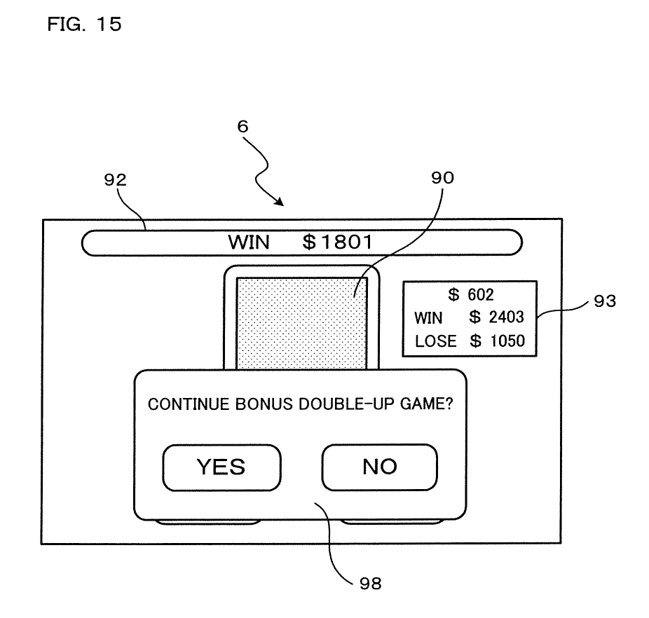

In S51, the main CPU 41 shows a message window 98 in the double-up game screen, as shown in FIG. 15. Based on the player's pressing either selection button “YES” or “NO”, the main CPU 41 determines whether the bonus double-up game continues or not.

Substantially simultaneously with showing the message window 98, the main CPU 41 updates contents shown in the window 93 (see FIGS. 14 and 15). More specifically, a remainder is set at 602 dollars, which is a result of subtracting the maximum tax-free amount 1199 dollars from the payout number 1801 dollars set in S49. The remainder 602 dollars thus set is an amount to be betted on a next bonus double-up game. Thus, a payout number given when the game is won is 2403 dollars which is a result of adding double the remainder 1204 dollars to the maximum tax-free amount 1199 dollars. A payout number given when the game is lost is still 1050 dollars which is the same as the first after-tax amount.

When the selection button “YES” is pressed, the main CPU 41 determines that the bonus double-up game continues (S51: YES), and the processing returns to S45. Then, a bonus double-up game is executed using a new bet amount 602 dollars. When the selection button “NO” is pressed, the main CPU 41 determines that the bonus double-up game ends (S51: NO), and the processing proceeds to S52.

In S52, the main CPU 41 calculates a second after-tax amount which is an amount after a tax is paid on the current payout number. The main CPU 41 sets a payout number at the second after-tax amount. In a case where in S49 the payout number has been set at 1801 dollars as described above, 540 dollars, which is 30% of the 1801 dollars, are paid as a tax. Thus, the second after-tax amount is 1261 dollars which is a result of subtracting 540 dollars from the 1801 dollars. The payout number is therefore set at 1261 dollars. Then, the main CPU 41 ends the bonus double-up game processing.

As thus far described above, after the basic double-up game is played, the bonus double-up game processing (S21) is executed on condition that the payout number is within the range for a bonus game. In S43, whether to execute the bonus double-up game or not is determined based on a selection made by a player. Accordingly, even when a player wins a payout equal to or more than the threshold amount and therefore a tax payment occurs, the player can get an opportunity for profit by executing the bonus double-up game. Thus, an amount actually paid to the player after tax payment can be restrained from becoming too smaller than the threshold amount. That is, a variation of an amount actually paid to the player, which occurs when a payout won is in the vicinity of the threshold amount, can be reduced. This can prevent fun of a game from being spoiled by tax payment.

The bonus double-up game is played using, as a bet amount, the remainder calculated by subtracting the maximum tax-free amount from the payout number. Like this, the bonus double-up game is played using an amount left after subtracting the maximum tax-free amount, which is close to the threshold amount, from the payout number. Therefore, an amount actually paid to the player after tax payment can more effectively be restrained from becoming too smaller than the threshold amount.

In either case of when the bonus double-up game is won (S48: YES) and when the bonus double-up game is lost (S48: NO), an amount after tax payment is set as a payout number (see S50 and S52). Then, in S22, the amount after tax payment is paid out to a player. Therefore, the player does not have to stop a game in order to perform a tax payment procedure which is in itself an incoherent operation. This can more surely prevent a game from being spoiled.

At the time when the amount after tax payment is paid out in S22, a receipt is printed by the ticket printer 30. A player carries the receipt to a predetermined section of a game arcade, so that a staff of the game arcade determines whether the player has already paid tax or not. The player performs a tax payment procedure at the predetermined section by, for example, signing. Consequently, the player does not have to perform the tax payment procedure during a game, and therefore fun of the game can be prevented from being spoiled. In addition, the player can perform tax payment procedures for several games at a time after the games.

In a case where the bonus double-up game is won, whether the bonus double-up game continues or not is determined in S51. By selecting to continue the bonus double-up game, a player gets an opportunity for a larger payout. As a result, a variation of an amount actually paid to the player, which occurs when a payout won is in the vicinity of the threshold amount, can be reduced more effectively.

The range for a bonus game adopted in S20 is from the threshold amount to less than an amount that, after tax, becomes equal to the threshold amount. That is, the bonus double-up game processing is executed when there occurs a situation where a player must feel very unfair because he/she has won a payout equal to or larger than a threshold amount but nevertheless an actual payout after tax is less than the threshold amount. As a result, the player can be given a chance to, when he/she has won a payout in the vicinity of the threshold amount, reduce a variation of an amount actually paid. Therefore, fun of the game can be prevented from being spoiled by a feeling of unfairness.

When a player selects not to execute the bonus double-up game (S43: NO), the maximum tax-free amount is paid out (S44). The player can keep playing a game without performing a tax payment procedure. Thus, the player does not have to stop a game in order to perform the tax payment procedure which is in itself an incoherent operation. Therefore, the player can enjoy fun of the game while maintaining excitement of winning a large amount of payout. Moreover, since the player can obtain at least the maximum tax-free amount depending on his/her own selection, a feeling of unfairness caused by tax payment can be reduced.

Even when a player loses the bonus double-up game, he/she can obtain at least the first after-tax amount (S50) Therefore, a feeling of unfairness can be reduced.

When a player wins the bonus double-up game, he/she can obtain a larger amount of payout. This can reduce his/her feeling of unfairness all the more.

A payout amount which will be given when execution or non-execution of the bonus double-up game is selected is indicated in each of the selection buttons 96 and 97. Thus, a player can see a profit that follows the selection, and therefore can make a selection so as to meet his/her demand.

The basic double-up game processing S19 is executed before S20. In the basic double-up game processing, a player can get an opportunity for a large payout. For example, even when a player wins a small amount of payout or even when an accumulated jackpot amount is small, the player may be given a large payout by executing the basic double-up game. This can enhance fun of the game because the player can expect a large amount of payout.

When a player wins the basic double-up game, as well as when a player wins the bonus double-up game, the player is given an opportunity for selecting to continue or non-continue the game. By selecting to continue the basic double-up game, a player gets an opportunity for a larger payout. This can further enhance fun of the game.

In the game system 105 of this embodiment, every time a game is played in each slot machine 1, the slot machine 1 transmits bet value data to the server 100 (S13), so that 1% of an amount indicated by the bet value data is accumulated in the accumulated jackpot amount storage area 103A (S102). When a slot machine 1 makes a “JACKPOT 7” win in S14, or when the server 100 wins a jackpot lottery in S103, it is determined that a jackpot is won (S105: YES). Then, the server 100 commands the slot machine 1 to set a payout number at an accumulated jackpot amount that is stored in the accumulated jackpot amount storage area 103A. This can enhance fun of the game because the player can expect a large amount of payout.

When either of the lottery in S14 and the jackpot lottery in the server 100 in S103 is won, that is, when for example the lottery is lost in S14 but the jackpot lottery in the server 100 is won in S103, the accumulated jackpot amount is set as a payout number. Therefore, a player can be surprised and excited at an unexpected large payout.

In the above-described embodiment, a coin, a bill, or valuable electronic information equivalent to them is adopted as a game medium. However, this is not limitative. For example, a medal, a token, electronic money, a ticket, and the like may be adopted as the game medium.

In the above-described embodiment, symbols which will be stopped are determined by lottery, and then one of several wins is determined. However, this is not limitative. For example, it may also be possible that one of several wins is firstly determined by lottery and then symbols which will be stopped are determined based on the win.

The slot machine 1 of the above-described embodiment is a mechanical slot machine which variably displays symbols by means of the reels 5L, 5C, and 5R. However, the slot machine 1 may be, for example, a so-called video slot machine which variably displays symbols by means of a display unit such as a liquid crystal display. In addition, the number of reels is not limited to three.

In the above-described embodiment, the lottery of win (S14) and the jackpot lottery (S103) are executed separately in the slot machine 1 and the server 100, respectively. However, both of the lotteries may be executed in the slot machine 1. Alternatively, it may also be possible to omit the jackpot lottery (S103) and determines whether the jackpot is won or not based only on a result of the lottery of win (S14).

In the above-described embodiment, when a payout number is equal to or more than the threshold amount, the amount that is left after paying tax on the payout number becomes an actual payout number, and the ticket printer 30 prints a receipt as such. However, it may also be possible that a player performs a tax payment procedure. In such a case, the tax payment procedure is preferably one that can be performed swiftly. For example, a staff of a game arcade may be called to directly perform a tax payment procedure. Alternatively, the slot machine 1 may be operated to perform a tax payment procedure (see Japanese Patent Unexamined Publication No. 2005-168755, for example)

The present invention is applicable to gaming machines other than slot machines. For example, the present invention can be applied to a gaming machine that offers a card game such as a poker game, a blackjack game, or the like.

The game system 105 is not necessarily applied in one game arcade. It may also be possible that, for example, the game system 105 includes the server 100 and the slot machines 1 that are placed in several game arcades in a certain region.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a receiving unit that receives a game medium;
a lottery unit that holds a lottery of a win;
a display unit that displays thereon a result of a lottery held by the lottery unit;
a payout unit that gives a payout to a player;
a first determination unit that determines whether or not a payout number based on the result of the lottery is equal to or more than a threshold amount at which tax obligation occurs;
a selection unit that selects, based on an input made by the player, whether or not to execute a bonus game which gives the player an opportunity for profit, when the first determination unit determines that the payout number is equal to or more than the threshold amount; and
a bonus game execution unit that executes the bonus game when the selection unit selects to execute the bonus game.

2. The gaming machine according to claim 1, wherein the bonus game execution unit executes the bonus game by use of an amount that is left after subtracting from the payout number an amount close to the threshold amount.

3. The gaming machine according to claim 1, further comprising a control unit that, when the bonus game execution unit executes the bonus game, controls the payout unit so as to pay out an amount that is left after paying a predetermined rate of tax on the payout number.

4. The gaming machine according to claim 3, wherein, when an amount left after paying a predetermined rate of tax on the payout number is paid out, the control unit controls the payout unit so as to record the amount on a record medium and output the record medium.

5. The gaming machine according to claim 1, further comprising a continuation selection unit that selects, based on an input made by the player, whether or not to continue the bonus game, when the bonus game execution unit executes the bonus game and besides the player wins a lottery in the bonus game.

6. The gaming machine according to claim 1, further comprising:
a second determination unit that determines whether an amount left after paying a predetermined rate of tax on a payout number based on the result of the lottery is less than the threshold value or not; and
a selection control unit that permits the selection unit to make a selection, when the first determination unit determines that the payout number is equal to or more than the threshold amount and besides the second determination unit determines that the payout number becomes less than the threshold amount after tax.

7. The gaming machine according to claim 1, further comprising a control unit that controls the payout unit so as to pay out a maximum amount less than the threshold amount, when the selection unit selects not to execute the bonus game.

8. The gaming machine according to claim 1, further comprising a control unit that, when the bonus game execution unit executes the bonus game and besides the player loses a lottery in the bonus game, controls the payout unit so as to pay out an amount left after paying a predetermined rate of tax on a payout number obtained before execution of the bonus game.

9. The gaming machine according to claim 1, further comprising a display control unit that displays a selection button on the display unit at the time when the selection unit makes a selection,
wherein the selection button shows a payout number which will be given when the bonus game is executed and a payout number which will be given when the bonus game is not executed.

10. The gaming machine according to claim 1, wherein a bonus game that is different from the bonus game and gives the player an opportunity for profit is executed before the first determination unit makes a determination.

11. A game system including a gaming machine and a server that is connected to the gaming machine so as to allow two-way communication therebetween,
wherein the gaming machine comprises: a receiving unit that receives a game medium; a lottery unit that holds a lottery of a win; a display unit that displays thereon a result of a lottery held by the lottery unit; a payout unit that gives a payout to a player; a first determination unit that determines whether or not a payout number based on the result of the lottery is equal to or more than a threshold amount at which tax obligation occurs; a selection unit that selects, based on an input made by the player, whether or not to execute a bonus game which gives the player an opportunity for profit, when the first determination unit determines that the payout number is equal to or more than the threshold amount; and a bonus game execution unit that executes the bonus game when the selection unit selects to execute the bonus game, and
wherein the game system comprises:
an accumulating unit that, every time a game is played in the gaming machine, accumulates a predetermined amount;
an accumulated payout lottery unit that holds a lottery of whether or not to pay out an amount accumulated by the accumulating unit; and
a payout commanding unit that commands, based on a result of a lottery held by the accumulated payout lottery unit, that the payout unit pay out an amount accumulated by the accumulating unit.

12. The game system according to claim 11, wherein the payout commanding unit commands that the payout unit pay out an amount accumulated by the accumulating unit based not only on a result of a lottery held by the accumulated payout lottery unit but also on a result of a lottery held by the lottery unit of the gaming machine.
